(19) United States
(12) Patent Application Publication
(10) Pub. No.: US 2025/0074421 A1
(43) Pub. Date: Mar. 6, 2025

(54) METHOD FOR CONTROLLING SPEED OF A VEHICLE USING A VEHICLE SPEED CONTROL SYSTEM, AND CONTROL ARRANGEMENT CONFIGURED TO PERFORM THE METHOD

(71) Applicant: Scania CV AB, Södertälje (SE)

(72) Inventors: Mikael Alenius, Segeltorp (SE); Manne Held, Älvsjö (SE); Elvedin Ramic, Åkers Stryckebruk (SE); Alexander Stamp, Huddinge (SE); Casper Johansson, Hägersten (SE)

(73) Assignee: Scania CV AB, Södertälje (SE)

(21) Appl. No.: 18/816,115

(22) Filed: Aug. 27, 2024

(30) Foreign Application Priority Data
Sep. 5, 2023 (SE) 2351043-1

(51) Int. Cl. B60W 30/18; B60T 17/18; B60W 30/14; B60W 50/00

(52) U.S. Cl. CPC B60W 30/18109; B60T 17/18; B60W 30/146; B60W 50/0097; B60W 2510/184; B60W 2720/10

(57) ABSTRACT

A control arrangement and a method for controlling travelling speed of a vehicle using a vehicle speed control system. The method comprises a step of, when the vehicle speed control system is expected to apply braking power using a service brake system and at least one of the one or more auxiliary brake systems of the vehicle while the vehicle travels an upcoming road section, predicting a future temperature profile for the service brake system based on a predetermined temperature model for the service brake system. The method further comprises a step of, when the predicted temperature profile demonstrates that the service brake system will reach a temperature above an upper temperature threshold, and optionally a first predefined criterion and/or a second predefined criterion is/are fulfilled, controlling the service brake system to reduce the vehicle speed.

### TECHNICAL FIELD

The present disclosure relates in general to a method for controlling travelling speed of a vehicle using a vehicle speed control system. The present disclosure further relates in general to a control arrangement configured to control travelling speed of a vehicle using a vehicle speed control system, and to a vehicle speed control system comprising such a control arrangement. The present disclosure also relates in general to a computer program, a computer-readable medium and to a vehicle.

### BACKGROUND

Vehicle speed control systems that automatically controls the travelling speed of a vehicle are common in modern vehicles. Examples of vehicle speed control systems include for example various types of cruise control systems. Another example of a vehicle speed control system is a downhill speed control system, which is a system configured to automatically brake the vehicle when the vehicle reaches a desired maximum vehicle speed, i.e. a set braking speed. A downhill speed control system may often be incorporated in a cruise control system. However, a downhill speed control system may also sometimes be used separately from a cruise control system, e.g., when a driver of the vehicle controls the vehicle speed through operation of an accelerator.

One example of a cruise control system is a traditional cruise control that aims at maintaining a substantially constant vehicle speed, such as a set speed selected by a driver of the vehicle. Such a traditional cruise control may often be referred to as a constant speed cruise control. A constant speed cruise control is typically configured to maintain the vehicle speed within a narrow allowable speed range about the set speed and with the aim to maintain the vehicle speed at the set speed. A constant speed cruise control thus controls the vehicle with the aim to maintain the set speed set regardless of whether the vehicle is travelling uphill, downhill or on a horizontal running surface. This means that the vehicle may be accelerated over the crest of a hill, only to be braked on a subsequent downgrade to avoid a too high vehicle speed. This is an uneconomic way of running the vehicle, particularly in the case of heavy vehicles, since it may often unduly increase the energy consumption of the vehicle and hence the operating costs (such as fuel costs).

Another type of cruise control is a predictive cruise control, sometimes also referred to as a look-ahead cruise control. A predictive cruise control is a cruise control which uses information regarding an upcoming road section, i.e. a road section ahead of the vehicle, and plans a driving strategy for the upcoming road section based on said information. The information regarding the upcoming road section may typically include at least topographic data and data relating to the curvature or the like of the upcoming road section, but could also for a more advanced predictive cruise control include information relating to for example traffic situation ahead of the vehicle and/or speed limits. The data may typically be derived from map data in combination with information regarding geographical positioning of the vehicle, and may in some situations also be supplemented with for example historical data relating to previous instances that the vehicle, or another vehicle, has travelled the upcoming road section. The predictive cruise control then controls the operation of the vehicle powertrain in accordance with the planned driving strategy as the vehicle travels the road section in question, which thereby results in the vehicle speed varying in accordance with a vehicle speed profile.

A predictive cruise control can save substantial amounts of energy compared to a constant speed cruise control. For example, in case the upcoming road section comprises an uphill followed by a downhill, the vehicle may be accelerated so as to, at the crest of the hill, have a speed which is lower than the set speed in situations where the vehicle speed may be increased during the downhill as a result of the gravitational force so as to reach the set speed. In order to take advantage of the positive effect obtainable by a predictive cruise control, the allowable speed range of the vehicle for such a cruise control is typically considerably broader than the allowable speed range of a constant speed cruise control. However, a predictive cruise control requires sufficiently accurate information regarding future conditions to which the vehicle will be subjected in order to function as intended. This means that it may not always be possible to use a predictive cruise control, for example in situations of loss of information or where there may be unknown factors affecting the operation of the vehicle. Thus, it may not always be possible to take advantage of energy savings obtainable by means of a predictive cruise control.

Another example of a vehicle speed control system is an adaptive cruise control system, which may e.g., be used to supplement a constant speed cruise control system or a predictive cruise control system. An adaptive cruise control system is a cruise control system configured to automatically adjust the vehicle speed in order to maintain a safe distance (or desired distance) to other road users ahead of the vehicle. An adaptive cruise control function typically uses information from sensors arranged in or on the vehicle, such as radar, laser or image capturing devices (such as cameras), for the purpose of obtaining information regarding such other road users in front of the vehicle.

Some vehicle speed control systems are configured to automatically request braking power from a service brake system of the vehicle, for example in situations when the deliverable braking power from auxiliary brake systems of the vehicle is insufficient for maintaining a desired maximum vehicle speed. Although this may facilitate maintaining the desired maximum vehicle speed, there is a risk of considerably heat build-up in the service brake system. Ultimately, this may lead to brake fading. One way of reducing the risk of brake fading could be to inhibit a request for braking power from the service brake system when the temperature of the service brake system reaches an upper temperature threshold. This may however lead to a situation where a driver of the vehicle, when seeking to maintain a desired maximum speed, must seek to reduce the vehicle speed with already hot service brakes.

WO 2004/048172 discloses an example of a method for distributing brake torque between at least a first and a second braking device on a vehicle, wherein the first braking device may be a service brake and the second braking device may be at least one auxiliary brake. The distribution of the brake torque takes place when the vehicle is driven with a cruise control function. According to the method, the distribution takes into account brake torque required and also the maximum brake torque the first braking device and second braking device can deliver. According to an embodiment of said method, the braking force of the first braking device is reduced when its temperature exceeds a predefined value.

Furthermore, it has previously been proposed to overcome the risk for overheating of a service brake system by (temporarily) reducing a set maximum vehicle speed during a braking event, such as a downhill, to thereby ensure that the available braking power of the auxiliary brake(s) is sufficient to maintain the reduced set maximum vehicle speed or at least that the need for usage of the service brake system is considerably reduced. However, this may lead to a decrease in average vehicle speed, which in turn prolongs the duration needed for the vehicle to travel an intended route.

### SUMMARY

The object of the present invention is to reduce the risk for overheating of a service brake system when travelling speed of the vehicle is controlled using a vehicle speed control system.

The object is achieved by the subject-matter of the appended independent claim(s).

The present disclosure relates to a method, performed by a control arrangement, for controlling travelling speed of a vehicle using a vehicle speed control system. The vehicle speed control system is configured to control vehicle speed through usage of a service brake system and one or more auxiliary brake systems of the vehicle. The method comprises a step of, when the vehicle speed control system is expected to apply braking power using the service brake system and at least one of the one or more auxiliary brake systems while the vehicle travels an upcoming road section, predicting a future temperature profile for the service brake system based on a predetermined temperature model for the service brake system. The method further comprises a step of, when the predicted temperature profile demonstrates that the service brake system will reach a temperature above an upper temperature threshold, and optionally a first predefined criterion and/or a second predefined criterion is/are fulfilled, controlling the service brake system to reduce the vehicle speed.

The herein described method considerably reduces the risk of the service brake system reaching such a high temperature that it may be overheated, which could otherwise lead to fading brakes or other thermal damage to the service brake system. Thus, the herein described method also inherently improves road safety. Furthermore, the reduced risk of the service brake system reaching a temperature at which it may become overheated is achieved without unduly reducing the average travelling speed of the vehicle while travelling the upcoming road section.

The fact that the herein described method comprises predicting a future temperature profile for the service brake system based on a predetermined temperature model enables action to be taken well before the service brake system may risk becoming overheated. In fact, this enables taking an action already when it is predicted that an upper temperature threshold, which may be selected with a suitable offset to a critical temperature for overheating, may be reached in the future. Furthermore, the action taken according to the present method is that the vehicle speed is reduced using the service brake system. A reduction of the vehicle speed, as such, reduces the risk of the service brake system becoming overheated since less total braking power from the available brake systems will thereafter be needed in order to prevent an increase of the vehicle speed above a desired maximum vehicle speed while the vehicle travels the upcoming road section. A lower needed total braking power from the available brake systems of the vehicle inherently leads to a lower needed braking power from the service brake system. The reduction of vehicle speed may also enable a longer cooling period for the service brake system before it may be needed in order to enable maintaining the desired maximum vehicle speed, such cooling period further reducing the risk for overheating of the service brake system. It may in some cases also enable longer cooling time for the auxiliary brake(s).

The method may further comprise a step of determining whether the first predefined criterion is fulfilled. The first predefined criterion may be determined to be fulfilled when the vehicle speed control system is expected to request, while the vehicle travels the upcoming road section, a braking power from the one or more auxiliary brake systems corresponding to a maximum available braking power from said one or more auxiliary brake systems. In case the vehicle speed control system is not expected to request a braking power from the one or more auxiliary brake systems which corresponds to maximum available braking power therefrom, it may be more appropriate to firstly seek to increase the requested braking power from the one or more auxiliary brake systems. This would in turn reduce the braking power needed from the service brake system and thereby also the energy to be absorbed thereby, which in turn reduces the risk for overheating of the service brake system.

The method may further comprise a step of determining whether the second predefined criterion is fulfilled. The second predefined criterion may be determined to be fulfilled when an estimated or measured current temperature of the service brake system is equal to or above a lower temperature threshold. Thereby, it may be avoided that the vehicle speed is reduced by the service brake system at a too early stage, when the temperature of the service brake system is still low. This in turn further ensures that the average vehicle speed as the vehicle travels the upcoming road section is not unduly reduced.

According to a first embodiment, the vehicle speed control system may be configured to control vehicle speed in accordance with a planned driving strategy for the upcoming road section, said planned driving strategy being determined in consideration of characteristics of said upcoming road section. Furthermore, the predetermined temperature model for the service brake system may take into account estimated energy to be absorbed by the service brake system. In such a case, the method may further comprise a step of estimating the energy to be absorbed by the service brake system resulting from a, by the vehicle speed control system, currently planned driving strategy for the upcoming road section. This has the advantage of improving the reliability in the predicted temperature profile of the service brake system since it takes into account the currently planned driving strategy for the upcoming road section. It also has the advantage of enabling reducing the vehicle speed by using the service brake system well in advance of the point at which the predicted temperature profile demonstrates that the temperature of the service brake system will exceed the upper temperature threshold. This may in turn allow for an even longer cooldown period for the service brake system, which also further contributes to reducing the risk of overheating.

According to a first alternative of the first embodiment, the method may further comprise a step of determining an amount of braking power, to be applied by the service brake system, sufficient to result in a driving strategy for the upcoming road section resulting in a predicted temperature profile for the service brake system which avoids temperatures above the upper temperature threshold. In such a case, the step of controlling the service brake system to reduce the vehicle speed may comprise controlling the service brake system to reduce the vehicle speed by applying said determined amount of braking power. This has the advantage of ensuring that the vehicle speed is sufficiently reduced to minimize the risk that the temperature of the service brake system exceeds the upper temperature threshold at some point while the vehicle travels the upcoming road section, while at the same time avoiding that the vehicle speed is reduced too much. It may in some cases also allow for even longer cooling time of the service brake system.

According to a second alternative of the first embodiment, the step of controlling the service brake system to reduce the vehicle speed may comprise controlling the service brake system to reduce the vehicle speed by a first predetermined speed reduction value. In such a case, the method may thereafter further comprise a steps of, when the vehicle speed control system is expected to control vehicle speed by applying braking power using service brake system and at least one of the one or more auxiliary brake systems while the vehicle continues to travel the upcoming road section, repeating the step of predicting a future temperature profile for the service brake system based on the predetermined temperature model for the service brake system. The method may thereafter further comprise a step of, when the predicted temperature profile demonstrates that the service brake system will reach a temperature above an upper temperature threshold, and optionally a first predefined criterion and/or a second predefined criterion is/are fulfilled, controlling the service brake system to reduce the vehicle speed by a second predetermined speed reduction value. The second alternative of the first embodiment has, compared to the first alternative of the first embodiment, the advantage of facilitating the herein described method since it avoids having to calculate an appropriate braking power, to be applied by the service brake system, sufficient to result in a driving strategy for the upcoming road section which corresponds to a predicted temperature profile for the service brake system that avoids temperatures above the upper temperature threshold.

According to a second embodiment of the herein described method, the method may further comprise a step of estimating energy to be absorbed by the service brake system to enable maintaining a maximum allowable vehicle speed in the upcoming road section based on currently applied braking power from the service brake system and the one or more auxiliary braking systems, and the predetermined temperature model for the service brake system taking into account said estimated energy to be absorbed by the service brake system. This allows the herein described method to be used also in cases where there is no planned driving strategy for the upcoming road section being determined based on the characteristics of the upcoming road section, for example in case the vehicle speed control system is a downhill speed control system which allows a driver of the vehicle to set a maximum allowable vehicle speed (also known as a brake speed) or a constant speed cruise control.

In case of the second embodiment of the herein described method, the step of controlling the service brake system to reduce the vehicle speed may comprise controlling the service brake system to reduce the vehicle speed by a predetermined speed reduction value. This inter alia avoids the need for calculations of an appropriate speed reduction to be achieved by the service brake system.

Additionally, or alternatively, the method according to the second embodiment may comprise repeating the steps of predicting a future temperature profile and controlling the service brake system to reduce the vehicle speed until a derivative of the predicted future temperature profile for the service brake system is below a predefined threshold value. This further reduces the risk for overheating of the service brake system while avoiding unduly lowering the average vehicle speed for the upcoming road section.

The present disclosure further relates to a computer program comprising instructions which, when executed by a computer, cause the computer to carry out the method as described above.

The present disclosure further relates to a computer-readable medium comprising instructions which, when executed by a computer, cause the computer to carry out the method as described above.

Moreover, the present disclosure provides a control arrangement configured to control travelling speed using a vehicle speed control system, wherein said vehicle speed control system is configured to control vehicle speed through usage of a service brake system and one or more auxiliary brake systems of the vehicle. The control arrangement is configured to, when the vehicle speed control system is expected to apply braking power using the service brake system and at least one of the one or more auxiliary brake systems while the vehicle travels an upcoming road section, predict a future temperature profile for the service brake system based on a predetermined temperature model for the service brake system. The control arrangement is further configured to, when the predicted temperature profile demonstrates that the service brake system will reach a temperature above an upper temperature threshold, and optionally a first predefined criterion and/or a second predefined criterion is/are fulfilled, control the service brake system to reduce the vehicle speed.

The control arrangement provides the same advantages as described above with reference to the corresponding method for controlling travelling speed of a vehicle using a vehicle speed control system.

The present disclosure also provides a vehicle speed control system configured to control travelling speed of a vehicle through usage of a service brake system and one or more auxiliary brake systems of the vehicle, the vehicle speed control system comprising the control arrangement described above. The vehicle speed control system may be a cruise control system, for example a predictive cruise control system or a constant speed cruise control system, but is not limited thereto.

The present disclosure also relates to a vehicle comprising the control arrangement described above. The vehicle may be a land-based heavy vehicle, such as a bus or a truck. The vehicle may for example be a fully electric vehicle, a hybrid vehicle, or a vehicle driven solely by a combustion engine. Furthermore, the vehicle may be a vehicle configured to a driven fully or in part by a driver. Alternatively, the vehicle may be a fully autonomous vehicle.

### BRIEF DESCRIPTION OF DRAWINGS

FIG. 1 schematically illustrates a side view of an example of a vehicle,

FIG. 2 represents a flowchart schematically illustrating an exemplifying embodiment of the herein described method for controlling vehicle speed using a vehicle speed control system,

FIG. 3 schematically illustrates an exemplifying embodiment of a device that may comprise, consist of, or be comprised in the herein described control arrangement configured to control travelling speed using a vehicle speed control system.

### DETAILED DESCRIPTION

The invention will be described in more detail below with reference to exemplifying embodiments and the accompanying drawings. The invention is however not limited to the exemplifying embodiments discussed and/or shown in the drawings, but may be varied within the scope of the appended claims. Furthermore, the drawings shall not be considered drawn to scale as some features may be exaggerated in order to more clearly illustrate the invention or features thereof.

In the present disclosure, the term “temperature profile” is used to describe a profile defining a variation in temperature over time and/or distance.

The terms “travelling speed of a vehicle” and “vehicle speed” are in the present disclosure used interchangeably. Moreover, the term “average vehicle speed” is herein intended to mean an average vehicle speed as the vehicle travels a road section. The average vehicle speed thus takes into account variation in vehicle speed that may occur as the vehicle travels the road section.

The present disclosure relates to a method, performed by a control arrangement, for controlling travelling speed of a vehicle though usage of a vehicle speed control system. Said vehicle speed control system is configured to control vehicle speed through usage of one or more auxiliary brake systems of the vehicle as well as, when needed or otherwise desired, a service brake system of the vehicle for the purpose of preventing an increase of vehicle speed above a desired maximum vehicle speed. The desired maximum vehicle speed may be set for example by a driver of the vehicle or by the vehicle speed control system. The vehicle speed control system may alternatively be described as a vehicle speed control system configured to control vehicle speed through brake blending of available brake systems of the vehicle in order to maintain a desired maximum vehicle speed, the available brake systems including at least one auxiliary brake system and a service brake system. Examples of auxiliary brake systems that may be comprised in the vehicle include, but are not limited to, an exhaust brake system, a variable vane brake (VVB) system, a compression release brake (CRB) system, a regenerative brake system, and a retarder.

The vehicle speed control system may for example be a downhill speed control system (separate from a cruise control system). Alternatively, the vehicle speed control system may be a cruise control system. The vehicle speed control system may for example be a predictive cruise control system, i.e. a cruise control system configured to control vehicle speed in accordance with a planned driving strategy for an upcoming road section, said planned driving strategy being determined in consideration of characteristic of said upcoming road section. Alternatively, the vehicle speed control system may be a constant speed cruise control system or an adaptive cruise control system.

The herein described method comprises a step of predicting a future temperature profile for the service brake system based on a predetermined temperature model for the service brake system, said step being performed when the vehicle speed control system is expected to apply braking power using the service brake system as well as at least one of the one or more auxiliary brake systems while the vehicle travels an upcoming road section. The vehicle speed control system may for example be expected to apply braking power using the service brake system and at least one of the one or more auxiliary brake systems while the vehicle travels an upcoming road section in case the vehicle speed control system is currently applying braking power to the vehicle using said brake systems. In case the vehicle speed control system constitutes e.g. a predictive cruise control, vehicle speed control system may be expected to apply braking power using the service brake system and at least one of the one or more auxiliary brake systems while the vehicle travels the upcoming road section in case this is part of a planned driving strategy for at least a portion of the upcoming road section.

As mentioned above, the prediction of a future temperature profile for the service brake system is made based on a predetermined temperature model for the service brake system. The temperature model for a service brake system of a vehicle may for example be determined through experimental tests and/or historical data, and the present disclosure is not limited to any particular predetermined temperature model. However, a predetermined temperature model may typically take into account estimated energy to be absorbed by the service brake system. The predetermined temperature model may typically also take into account other factors, such as vehicle mass, (estimated or measured) current temperature of the service brake system and heat dissipation from the service brake system. It should here be noted that factors taken into account by the predetermined temperature model of the service brake system may vary over time, and may also be dependent on for example on vehicle speed, weather conditions, etc. Various temperature models for service brake systems of vehicles are as such previously known, and will therefore not be further discussed in the present disclosure.

The herein described method further comprises a step of, when the predicted temperature profile demonstrates that the service brake system will reach a temperature above an upper temperature threshold, controlling the service brake system to reduce the vehicle speed. This means that the service brake system is used for the purpose of reducing the current vehicle speed to a lower vehicle speed. According to one embodiment of the herein described method, said step of controlling the service brake system to reduce the vehicle speed when the predicted temperature profile demonstrates that the service brake system will reach a temperature above the upper temperature threshold is performed only if a first predefined criterion is also fulfilled. According to another embodiment of the herein described method, the step of controlling the service brake system to reduce the vehicle speed when the predicted temperature profile demonstrates that the service brake system will reach a temperature above the upper temperature threshold is performed only if a second predefined criterion is also fulfilled. According to yet an embodiment of the herein described method, the step of controlling the service brake system to reduce the vehicle speed when the predicted temperature profile demonstrates that the service brake system will reach a temperature above the upper temperature threshold is performed only if both said first predefined criterion is fulfilled and said second predefined criterion is fulfilled.

When the vehicle speed has been reduced by usage of the service brake system, the braking power requested therefrom may, depending on the circumstances, be reduced or even interrupted. This may enable cooling of the service brake system before it may possibly be needed in order to maintain a desired maximum vehicle speed.

The above mentioned upper temperature threshold may be selected to correspond to a temperature well below a critical temperature of the service brake system. A critical temperature of the service brake system shall here be understood to mean a temperature at which brake fading may occur (also known as fade point), or at which the service brake system may otherwise be damaged due to the high temperature. The upper temperature threshold may for example be selected to be at least 100° C., preferably at least 200° C., below the critical temperature.

As mentioned above, the step of controlling the service brake system to reduce the vehicle speed may according to some embodiments of the herein described method be performed only if also a first predefined criterion and/or a second predefined criterion is/are fulfilled. Such embodiments of the herein described method may for example ensure that the vehicle speed is not reduced by the service brake system in situations where there may be a more appropriate solution for avoiding or at least reducing the risk for overheating of the service brake system when the vehicle travels the upcoming road section, or at such an early stage that it may risk an undue reduction of the average vehicle speed for the upcoming road section. The herein described method may naturally also comprise a step of determining whether the first predefined criterion is fulfilled. Alternatively or additionally, the method may comprise a step of determining whether the second predefined criterion is fulfilled.

The first predefined criterion may for example be that the vehicle cruise control system is expected to request, while the vehicle travels the upcoming road section, a braking power from the one or more auxiliary brake systems of the vehicle which corresponds to the maximum available braking power therefrom. In situations where the one or more auxiliary brake systems are not utilized so as to provide the maximum available braking power therefrom for the purpose of preventing an increase of vehicle speed above a desired maximum vehicle speed, it may be more appropriate to increase the requested power from the one or more auxiliary brake systems. Thereby, less braking power may be needed from the service brake system to prevent an increase of vehicle speed above the desired maximum vehicle speed, which in turn means that less energy needs to be absorbed by the service brake system and thereby a reduction of the temperature increase of the service brake system.

The second predefined criterion may for example be that a current temperature of the service brake system is equal to or above a lower temperature threshold, wherein said current temperature may be a measured temperature or an estimated temperature of the service brake system. The primary reason for applying such a criterion is to avoid reducing the vehicle speed at a too early stage. In case the current temperature of the service brake system is relatively low, there is generally no imminent risk for overheating of the service brake system. Such a second predefined criterion is especially suitable to apply in case of the vehicle speed control system is a predictive cruise control system in view of the extended temperature predictions that are enabled compared to e.g. a constant speed cruise control system.

Alternatively, any one of the first predefined criterion and the second predefined criterion may for example be that the predicted temperature profile demonstrates that the service brake system will reach a temperature above the upper temperature threshold (i) within a certain distance from the current position of the vehicle, (ii) within a certain distance range of the upcoming road section distanced from the current position of the vehicle, (iii) within a certain point in time, or (iv) within a certain (future) time interval.

As previously mentioned, the vehicle speed control system may according to one embodiment be a vehicle speed control system configured to control vehicle speed in accordance with a planned driving strategy for an upcoming road section in front of the vehicle, i.e. a predictive cruise control system. A predictive cruise control system may for example be configured to determine a suitable driving strategy for the upcoming road section based on simulation of a plurality of vehicle speed profiles for various driving strategies for the upcoming road section, and selecting the simulated vehicle speed profile which appears to be the most appropriate from the plurality of simulated vehicle speed profiles as the planned driving strategy to be used for the control of vehicle speed. Typically, the driving strategy resulting in the most energy efficient vehicle speed profile, which is able to keep the vehicle speed within the allowable vehicle speed range, is thereafter selected as the planned driving strategy. However, other factors, such as driver comfort and/or time to reach a destination, may also be considered when selecting among the simulated vehicle speed profiles. A simulated vehicle speed profile defines simulated vehicle speed at different distance points along the upcoming road section and at least comprises the extreme points, i.e. the simulated maximum vehicle speed together with its associated distance point as well as the simulated minimum vehicle speed with its associated distance point. The simulated vehicle speed profile may comprise or consist of a plurality of simulated discrete values of vehicle speed at various distance points along the road section. Suitably, the simulated vehicle speed profile may be a simulated continuous vehicle speed profile. Simulation of a vehicle speed profile for an upcoming road section is nowadays well known to a person skilled in the art and will therefore not be described in detail here. Examples of factors that may typically be considered in such a simulation, in addition to characteristics of the upcoming road section (such as topography, curvature of road etc.), include for example vehicle configuration, vehicle load etc. Advanced simulations of vehicle speed profiles for upcoming road sections may also take into consideration additional factors, such as weather conditions and/or traffic situation. A predictive cruise control system is furthermore typically configured to reassess the planned driving strategy as the vehicle continues to travels the upcoming road section. This may be performed by repeating the above described simulations, which also means that the planned driving strategy may be revised based on new conditions.

In case the vehicle speed control system is a predictive cruise control system, the method may further comprise a step of estimating energy to be absorbed by the service brake system resulting from the currently planned driving strategy for the upcoming road section, said currently planned driving strategy being selected by the predictive cruise control system. Said estimated energy to be absorbed by the service brake system may be taken into account by the predetermined temperature model for the service brake system. Knowledge of the planned driving strategy for the upcoming road section inherently means that there is also a knowledge of the planned brake power to be applied by the various brake systems of the vehicle as the vehicle travels the upcoming road section. Thus, this inter alia means that the reliability of the predicted temperature profile for the service brake system is improved.

Furthermore, in case the vehicle speed control system is a predictive cruise control system, the method may further comprise a step of determining an amount of braking power, to be applied by the service brake system, sufficient to result in a driving strategy for the upcoming road section resulting in a predicted temperature profile for the service brake system which avoids (i.e. does not demonstrate) temperatures above the upper temperature threshold. In such a case, the step of controlling the service brake system to reduce the vehicle speed may comprise controlling the service brake system to reduce the vehicle speed by applying said determined amount of braking power. Described differently, the method may comprise determining the vehicle speed reduction needed in order to avoid that the temperature of the service brake system would exceed the upper temperature threshold and determining the corresponding amount of brake power from the service brake system needed to achieve such a speed reduction. This has the advantage of ensuring that the vehicle speed is sufficiently reduced to minimize the risk that the temperature of the service brake system exceeds the upper temperature threshold at some point while the vehicle travels the upcoming road section, while at the same time avoiding that the vehicle speed is reduced too much. It may in some cases also allow for longer cooling time of the service brake system.

In case the step of controlling the service brake system to reduce the vehicle speed does not comprise reducing the vehicle speed by applying the above described determined amount of braking power by the service brake system, the step of controlling the service brake system to reduce the vehicle speed may instead comprise controlling the service brake system to reduce the vehicle speed by a first predetermined speed reduction value. Such a predetermined speed reduction value may be dependent on a current travelling speed of the vehicle. Furthermore, the first predetermined speed reduction value is typically a relatively low value, such as 1 km/h, 2 km/h, or 3 km/h, in order not to result in an unduly high reduction of average vehicle speed for the upcoming road section. Furthermore, the method may thereafter further comprise a steps of, at least in case the vehicle speed control system is expected to control vehicle speed by applying braking power using service brake system and at least one of the one or more auxiliary brake systems while the vehicle continues to travel the upcoming road section, repeating the step of predicting a future temperature profile for the service brake system based on the predetermined temperature model for the service brake system. In view of the reduction in vehicle speed achieved by the service brake system, the newly predicted temperature profile for the service brake system may typically differ from initially predicted temperature profile therefore. The method may thereafter further comprise a step of, when the (newly) predicted temperature profile demonstrates that the service brake system will reach a temperature above an upper temperature threshold, and optionally the first predefined criterion and/or the second predefined criterion is/are fulfilled, controlling the service brake system to reduce the vehicle speed by a second predetermined speed reduction value. The first and second predetermined speed reduction values may be selected to be equal or to be different.

Moreover, as previously mentioned, the vehicle speed control system need not necessarily be a predictive cruise control system, but may for example be a constant speed cruise control system, an adaptive cruise control system, or a downhill speed control system being separate from a cruise control system and in which e.g., a driver or a controller of the vehicle has set a maximum allowable vehicle speed. For such vehicle speed control systems, there is no pre-planned driving strategy for the upcoming road section from which an intended use of the available brake system may be derived. A predictive cruise control system allows for predicting longer future temperature profiles for the service brake system, in view of the presence of a planned driving strategy, compared to other vehicle speed control systems.

Therefore, in case the vehicle speed control system is not a predictive cruise control system, the method may for example comprise a step of estimating energy to be absorbed by the service brake system to enable maintaining a maximum allowable vehicle speed in the upcoming road section based on currently applied braking power from the service brake system and the one or more auxiliary braking systems. Naturally, additional factors may be taken into account when making said estimation, such as road inclination. Said estimated energy to be absorbed by the service brake system may thereby be taken into account by the predetermined temperature model for the purpose of predicting the future temperature profile of the service brake system.

Furthermore, in view of the lack of a planned driving strategy for the upcoming road section for such vehicle speed control systems, the step of controlling the service brake system to reduce the vehicle speed may comprise controlling the service brake to reduce the vehicle speed by a predetermined speed reduction value. Such a predetermined speed reduction value may be dependent on a current travelling speed of the vehicle, and may be a relatively low value, such as 1 km/h, 2 km/h, or 3 km/h, in order not to result in an unduly high reduction of average vehicle speed for the upcoming road section.

The method may further comprise repeating the steps of predicting a future temperature profile followed by controlling the service brake system to reduce the vehicle speed as many times as needed. As mentioned above, the predicted temperature profile for the service brake system will be considerably shorter compared to when the vehicle speed control system is a predictive cruise control system. In view thereof, the steps of predicting a future temperature profile and controlling the service brake system to reduce the vehicle speed may suitably be repeated until a derivative of the predicted future temperature profile for the service brake system is below a predefined threshold value. Thereby, it may for example be ensured that the vehicle speed is not reduced too much such that the average vehicle speed would be unduly low.

The performance of the herein described method for controlling travelling speed of a vehicle may be governed by programmed instructions. These programmed instructions may take the form of a computer program which, when executed by a computer, cause the computer to effect desired forms of control action(s). Such a computer may for example be comprised in the control arrangement as described herein. A computer is in the present disclosure considered to mean any hardware or hardware/firmware device implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, an application-specific integrated circuit, or any other device capable of electronically performing operations in a defined manner.

The above described programmed instructions, which may take the form of a computer program, may be stored on a computer-readable medium. Hence, the present disclosure also relates to a computer-readable medium storing instructions, which when executed by computer, cause the computer to carry out the herein described method for controlling travelling speed of a vehicle. The computer-readable medium may be a non-transitory computer-readable medium, such as a tangible electronic, magnetic, optical, infrared, electromagnetic, and/or semiconductor system, apparatus, and/or device.

The present disclosure further relates to a control arrangement configured to control travelling speed of a vehicle using a vehicle speed control system. The control arrangement may be configured to perform any one of the steps of the herein described method for controlling travelling speed of a vehicle using a vehicle speed control system.

More specifically, the present disclosure provides a control arrangement configured to control travelling speed of a vehicle using a vehicle speed control system. Said vehicle speed control system is configured to control vehicle speed through usage of one or more auxiliary brake systems of the vehicle as well as, when needed or otherwise desired, a service brake system of the vehicle for the purpose of preventing an increase of vehicle speed above a desired maximum vehicle speed. The control arrangement is configured to, when the vehicle speed control system is expected to apply braking power using the service brake system and at least one of the one or more auxiliary brake systems while the vehicle travels an upcoming road section, predict a future temperature profile for the service brake system based on a predetermined temperature model for the service brake system. The control arrangement is further configured to, when the predicted temperature profile demonstrates that the service brake system will reach a temperature above an upper temperature threshold, control the service brake system so as to reduce the vehicle speed. Optionally, the control arrangement may be configured to control the service brake system to reduce the vehicle speed when the predicted temperature profile demonstrates that the service brake system will reach a temperature above an upper temperature threshold only if a first predefined criterion is fulfilled and/or a second predefined criterion is fulfilled.

The control arrangement may be configured to determine whether the first predefined criterion is fulfilled. As already mentioned above, the first predefined criterion may be determined to be fulfilled when the vehicle speed control system is expected to request, while the vehicle travels the upcoming road section, a braking power from the one or more auxiliary brake systems of the vehicle that corresponds to a maximum available braking power therefrom.

In case the vehicle speed control system is a predictive cruise control and it is determined that the first predefined criterion is not fulfilled, the control arrangement may be configured to adjust the planned driving strategy of the cruise control system for the upcoming road section to a driving strategy leading to an increase in the braking power to be requested from the one or more auxiliary brake systems; and thereafter predict a future temperature profile of the service brake system based on the predetermined temperature model for the service brake system and the adjusted driving strategy. If it is determined that the predicted future temperature profile, being based on the adjusted driving strategy, demonstrates that the service brake system will reach a temperature above the upper temperature threshold, the control arrangement may be configured to control the service brake system to reduce the vehicle speed.

In case the vehicle speed control system is not a predictive cruise control system and it is determined that the first predefined criterion is not fulfilled, the control arrangement may for example be configured to control the vehicle speed control system to increase the braking power requested from the one or more auxiliary brake systems; and thereafter repeat the steps of the herein described method.

The control arrangement may further be configured to determine whether the second predefined criterion is fulfilled. As already mentioned above, the second predefined criterion may be determined to be fulfilled when an estimated or measured current temperature of the service brake system is equal to or above a lower temperature threshold.

The control arrangement may comprise one or more control units. In case of the control arrangement comprising a plurality of control units, each control unit may be configured to control a certain function or a certain function may be divided between more than one control units. The control arrangement may be a control arrangement of a vehicle speed control system of the vehicle, such as a cruise control system of the vehicle. Alternatively, the control arrangement may be separate from the vehicle speed control system, but configured to communicate therewith for the purpose of control thereof. The control arrangement may also be a part of any other controller of the vehicle. The control arrangement may be arranged in the vehicle. It is however also plausible that one or more control units of the control arrangement may be arranged at a remote control center or the like, and configured to communicate with one or more control units (of the control arrangement) arranged onboard the vehicle.

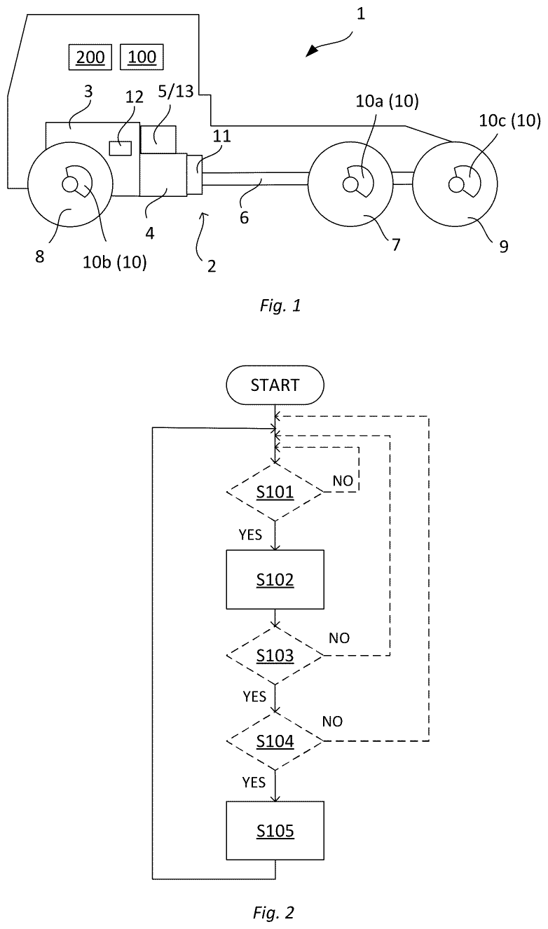

FIG. 1 schematically illustrates a side view of an example of a vehicle 1, here illustrated as a truck. The exemplified vehicle 1 comprises a powertrain 2 comprising a combustion engine 3 serving as a propulsion unit, and a gearbox 4. The combustion engine 3 may be connected to the gearbox via a clutch (not shown). The gearbox 4 may be connected to the driving wheels 7 of the vehicle 1 via an output shaft 6 of the gearbox 4. The vehicle further comprises front wheels 8 and optionally also tag axle wheels 9. It should be noted that although FIG. 1 illustrates a vehicle 1 comprising driving wheels 7 arranged in front of tag axle wheels 9, and thus a driven axle in front of the tag axle, a possible tag axle may alternatively or additionally be arranged in front of the drive axle in case the vehicle comprises such a tag axle. The vehicle 1 may alternatively, or additionally, comprise a plurality of driven axles with associated driving wheels 7.

As previously mentioned, the present disclosure is not limited to a vehicle driven solely by a combustion engine. The vehicle 1 may additionally, or alternatively, comprise one or more electrical machines 5 (only one shown in the figure) serving as a propulsion unit.

The vehicle 1 comprises a service brake system 10. The service brake system may comprise service brakes 10a arranged at the respective driving wheels 7, service brakes 10b arranged at the front wheels 8 and/or service brakes 10c arranged at any other wheel of the vehicle 1 as shown in the figure.

The vehicle 1 further comprises one or more auxiliary brake systems. For example, the vehicle 1 may comprise an auxiliary brake system in the form of a retarder 11. Such a retarder 11 may for example be connected to an output shaft of the gearbox 4 as illustrated in the figure. Alternatively, the retarder may be connected to a shaft of the combustion engine 3. Additionally, or alternatively, the vehicle 1 may comprise an auxiliary brake system in the form of an engine brake system 12. The engine brake system 12 may for example be a compression release brake system, an exhaust brake system, or a variable vane brake system. Furthermore, when present, the electrical machine 5 may also serve as an auxiliary brake system in the form of a regenerative brake system 13. When serving as a regenerative brake system 13, the electrical machine 5 is operated as generator for the purpose of converting kinetic energy of the vehicle to electrical energy which for example may be used to charge an energy storage device (not shown) of the vehicle. The energy stored in the energy storage device may thereafter be used for the purpose of driving the electrical machine when the electrical machine is operated as a propulsion unit of the vehicle.

The vehicle 1 may further comprise the herein described control arrangement 100 configured to control vehicle speed using a vehicle speed control system. The vehicle 1 may also comprise a vehicle speed control system 200. The vehicle speed control system 200 may for example be a downhill speed control system or a cruise control system. The control arrangement 100 may be a part of the vehicle speed control system 200. Alternatively, the control arrangement 100 may be separate from the vehicle speed control 200, but configured to communicate therewith.

FIG. 2 represents a flowchart schematically illustrating an exemplifying embodiment of the herein described method for controlling vehicle speed using a vehicle speed control system. Optional steps of the exemplifying embodiment are shown by dashed lines.

The method may comprise a step S101 of determining whether the vehicle speed control system may be expected to apply braking power using the service brake system and at least one of the one or more auxiliary brake systems while the vehicle travels an upcoming road section. In case the vehicle speed control system is not expected to apply braking torque using both the service brake system and at least one auxiliary brake system of the vehicle, the method may be reverted to start. However, if it is expected that the vehicle speed control system will apply braking power using both the service brake system and at least one auxiliary brake system, the method proceeds to the subsequent step S102. In case the method per se does not comprise step S101, it may be initiated in response to a determination that the vehicle speed control system is expected to apply braking torque using both the service brake system and at least one auxiliary brake system of the vehicle.

The method comprises a step S102 of predicting a future temperature profile for the service brake system based on a predetermined temperature model for the service brake system.

The method may optionally further comprise a step S103 of determining whether a first predefined criterion is fulfilled. If it is determined that the first predefined criterion is not fulfilled, the method may be reverted to start. However, if it is determined that the first predefined criterion is fulfilled, the method proceeds to a subsequent step.

Moreover, the method may optionally comprise a step S104 of determining whether a second predefined criterion is fulfilled. If it is determined that the second predefined criterion is not fulfilled, the method may be reverted to start. However, if it is determined that the second predefined criterion is fulfilled, the method proceeds to a subsequent step.

It should here be noted that, in case the method comprises both the optional step S103 and the optional step S104, these steps may be performed in any order, or in parallel.

The method further comprises a step S105 of, when the predicted temperature profile demonstrates that the service brake system will reach a temperature above an upper temperature threshold, controlling the service brake system to reduce the vehicle speed. Step S105 may for example comprise controlling the service brake system to reduce the vehicle speed by a predetermined speed reduction value. After step S105, the method may be reverted to start.

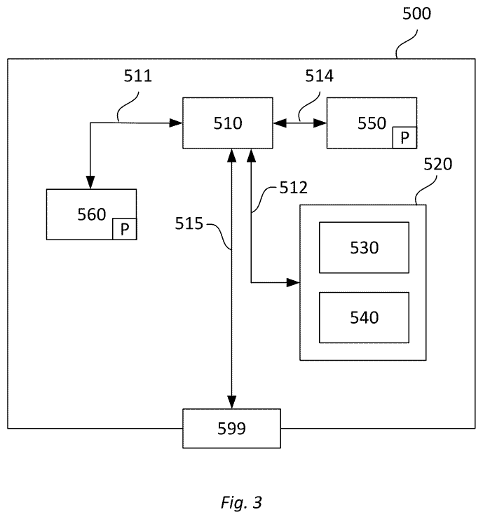

FIG. 3 schematically illustrates an exemplifying embodiment of a device 500. The control arrangement 100 described above may for example comprise the device 500, consist of the device 500, or be comprised in the device 500.

The device 500 comprises a non-volatile memory 520, a data processing unit 510 and a read/write memory 550. The non-volatile memory 520 has a first memory element 530 in which a computer program, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

There is provided a computer program P that comprises for controlling travelling speed of a vehicle using a vehicle speed control system. Said vehicle speed control system is configured to control vehicle speed through usage of a service brake system and one or more auxiliary brake systems of the vehicle. The computer program comprises instructions for, when the vehicle speed control system is expected to apply braking power using the service brake system and at least one of the one or more auxiliary brake systems while the vehicle travels an upcoming road section, predicting a future temperature profile for the service brake system based on a predetermined temperature model for the service brake system. The computer program further comprises instructions for, when the predicted temperature profile demonstrates that the service brake system will reach a temperature above an upper temperature threshold, and optionally a first predefined criterion and/or a second predefined criterion is/are fulfilled, controlling the service brake system to reduce the vehicle speed.

The program P may be stored in an executable form or in a compressed form in a memory 560 and/or in a read/write memory 550.

The data processing unit 510 may perform one or more functions, i.e. the data processing unit 510 may effect a certain part of the program P stored in the memory 560 or a certain part of the program P stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit 510 via a data bus 511. The read/write memory 550 is adapted to communicate with the data processing unit 510 via a data bus 514. The communication between the constituent components may be implemented by a communication link. A communication link may be a physical connection such as an optoelectronic communication line, or a non-physical connection such as a wireless connection, e.g. a radio link or microwave link.

When data are received on the data port 599, they may be stored temporarily in the second memory element 540. When input data received have been temporarily stored, the data processing unit 510 is prepared to effect code execution as described above.

Parts of the methods herein described may be affected by the device 500 by means of the data processing unit 510 which runs the program stored in the memory 560 or the read/write memory 550. When the device 500 runs the program, the method described herein is executed.

1. A method, performed by a control arrangement, for controlling travelling speed of a vehicle using a vehicle speed control system,
said vehicle speed control system being configured to control vehicle speed through usage of a service brake system and one or more auxiliary brake systems of the vehicle,
the method comprising:
when the vehicle speed control system is expected to apply braking power using the service brake system and at least one of the one or more auxiliary brake systems while the vehicle travels an upcoming road section, predicting a future temperature profile for the service brake system based on a predetermined temperature model for the service brake system; and
when the predicted temperature profile demonstrates that the service brake system will reach a temperature above an upper temperature threshold, controlling the service brake system to reduce the vehicle speed.

2. The method according to claim 16, further comprising determining whether the first predefined criterion is fulfilled,
wherein the first predefined criterion is fulfilled when the vehicle speed control system is expected to request, while the vehicle travels the upcoming road section, a braking power from the one or more auxiliary brake systems corresponding to a maximum available braking power from said one or more auxiliary brake systems.

3. The method according to claim 16, further comprising determining whether the second predefined criterion is fulfilled,
wherein the second predefined criterion is fulfilled when an estimated or measured current temperature of the service brake system is equal to or above a lower temperature threshold.

4. The method according to claim 1, wherein
the vehicle speed control system is configured to control vehicle speed in accordance with a planned driving strategy for the upcoming road section, said planned driving strategy being determined in consideration of characteristics of said upcoming road section, and
the predetermined temperature model for the service brake system takes into account estimated energy to be absorbed by the service brake system,
the method further comprising estimating an amount of energy to be absorbed by the service brake system resulting from a currently planned driving strategy of the vehicle speed control system for the upcoming road section.

5. The method according to claim 4,
wherein the method further comprises determining an amount of braking power, to be applied by the service brake system, sufficient to result in a driving strategy for the upcoming road section resulting in a predicted temperature profile for the service brake system which avoids temperatures above the upper temperature threshold, and
wherein controlling the service brake system to reduce the vehicle speed comprises controlling the service brake system to reduce the vehicle speed by applying said determined amount of braking power.

6. The method according to claim 4,
wherein controlling the service brake system to reduce the vehicle speed comprises controlling the service brake system to reduce the vehicle speed by a first predetermined speed reduction value, and
the method thereafter further comprising:
when the vehicle speed control system is expected to control vehicle speed by applying braking power using service brake system and at least one of the one or more auxiliary brake systems while the vehicle continues to travel the upcoming road section, repeating the step of predicting a future temperature profile for the service brake system based on the predetermined temperature model for the service brake system; and
when the predicted temperature profile demonstrates that the service brake system will reach a temperature above an upper temperature threshold, controlling the service brake system to reduce the vehicle speed by a second predetermined speed reduction value.

7. The method according to claim 1, further comprising:
estimating energy to be absorbed by the service brake system to enable maintaining a maximum allowable vehicle speed in the upcoming road section based on currently applied braking power from the service brake system and the one or more auxiliary braking systems, and
wherein the predetermined temperature model for the service brake system takes into account said estimated energy to be absorbed by the service brake system.

8. The method according to claim 7, wherein controlling the service brake system to reduce the vehicle speed comprises controlling the service brake system to reduce the vehicle speed by a predetermined speed reduction value.

9. The method according to claim 7, further comprising repeating the steps of predicting a future temperature profile and controlling the service brake system to reduce the vehicle speed until a derivative of the predicted future temperature profile for the service brake system is below a predefined threshold value.

10. A computer program product stored on a non-transitory computer-readable medium, said computer program product for controlling travelling speed of a vehicle using a vehicle speed control system, said vehicle speed control system being configured to control vehicle speed through usage of a service brake system and one or more auxiliary brake systems of the vehicle, wherein said computer program product comprising computer instructions to cause one or more computing devices to perform the following operations:
when the vehicle speed control system is expected to apply braking power using the service brake system and at least one of the one or more auxiliary brake systems while the vehicle travels an upcoming road section, predict a future temperature profile for the service brake system based on a predetermined temperature model for the service brake system; and
when the predicted temperature profile demonstrates that the service brake system will reach a temperature above an upper temperature threshold, control the service brake system to reduce the vehicle speed.

11. (canceled)

12. A control arrangement configured to control travelling speed of a vehicle using a vehicle speed control system,
said vehicle speed control system being configured to control vehicle speed through usage of a service brake system and one or more auxiliary brake systems of the vehicle,
the control arrangement being configured to:
when the vehicle speed control system is expected to apply braking power using the service brake system and at least one of the one or more auxiliary brake systems while the vehicle travels an upcoming road section, predict a future temperature profile for the service brake system based on a predetermined temperature model for the service brake system; and
when the predicted temperature profile demonstrates that the service brake system will reach a temperature above an upper temperature threshold, control the service brake system to reduce the vehicle speed.

13. A vehicle speed control system configured to control travelling speed of a vehicle through usage of a service brake system and one or more auxiliary brake systems of the vehicle, the vehicle speed control system comprising a control arrangement being configured to:
when the vehicle speed control system is expected to apply braking power using the service brake system and at least one of the one or more auxiliary brake systems while the vehicle travels an upcoming road section, predict a future temperature profile for the service brake system based on a predetermined temperature model for the service brake system; and
when the predicted temperature profile demonstrates that the service brake system will reach a temperature above an upper temperature threshold, control the service brake system to reduce the vehicle speed.

14. The vehicle speed control system according to claim 13, wherein the vehicle speed control system is a cruise control system.

15. A vehicle comprising a control arrangement configured to control travelling speed of a vehicle using a vehicle speed control system,
said vehicle speed control system being configured to control vehicle speed through usage of a service brake system and one or more auxiliary brake systems of the vehicle,
the control arrangement being configured to:
when the vehicle speed control system is expected to apply braking power using the service brake system and at least one of the one or more auxiliary brake systems while the vehicle travels an upcoming road section, predict a future temperature profile for the service brake system based on a predetermined temperature model for the service brake system; and
when the predicted temperature profile demonstrates that the service brake system will reach a temperature above an upper temperature threshold, control the service brake system to reduce the vehicle speed.

16. The method according to claim 1, wherein controlling the service brake system to reduce the vehicle speed comprises controlling the service brake system to reduce the vehicle speed, when: (i) the predicted temperature profile demonstrates that the service brake system will reach a temperature above an upper temperature threshold, and (ii) a first predefined criterion and/or a second predefined criterion is/are fulfilled.

17. The computer program product according to claim 10, wherein controlling the service brake system to reduce the vehicle speed comprises controlling the service brake system to reduce the vehicle speed, when: (i) the predicted temperature profile demonstrates that the service brake system will reach a temperature above an upper temperature threshold, and (ii) a first predefined criterion and/or a second predefined criterion is/are fulfilled.

18. The control arrangement according to claim 12, wherein controlling the service brake system to reduce the vehicle speed comprises controlling the service brake system to reduce the vehicle speed, when (i) the predicted temperature profile demonstrates that the service brake system will reach a temperature above an upper temperature threshold and (ii) a first predefined criterion and/or a second predefined criterion is/are fulfilled.

19. The vehicle speed control system according to claim 13, wherein controlling the service brake system to reduce the vehicle speed comprises controlling the service brake system to reduce the vehicle speed, when (i) the predicted temperature profile demonstrates that the service brake system will reach a temperature above an upper temperature threshold and (ii) a first predefined criterion and/or a second predefined criterion is/are fulfilled.

20. The vehicle according to claim 15, wherein controlling the service brake system to reduce the vehicle speed comprises controlling the service brake system to reduce the vehicle speed, when (i) the predicted temperature profile demonstrates that the service brake system will reach a temperature above an upper temperature threshold and (ii) a first predefined criterion and/or a second predefined criterion is/are fulfilled.

21. The method according to claim 4,
wherein controlling the service brake system to reduce the vehicle speed comprises controlling the service brake system to reduce the vehicle speed by a first predetermined speed reduction value, and
the method thereafter further comprising:
when the vehicle speed control system is expected to control vehicle speed by applying braking power using service brake system and at least one of the one or more auxiliary brake systems while the vehicle continues to travel the upcoming road section, repeating the step of predicting a future temperature profile for the service brake system based on the predetermined temperature model for the service brake system; and
(i) when the predicted temperature profile demonstrates that the service brake system will reach a temperature above an upper temperature threshold, and (ii) a first predefined criterion and/or a second predefined criterion is/are fulfilled, controlling the service brake system to reduce the vehicle speed by a second predetermined speed reduction value.
